(19) United States
(12) Patent Application Publication
(10) Pub. No.: US 2026/0077714 A1
(43) Pub. Date: Mar. 19, 2026

(54) MIRROR SUPPORT AND MIRROR ASSEMBLY HAVING SAME

(71) Applicant: LG ELECTRONICS INC., Seoul (KR)

(72) Inventor: Kiman SONG, Seoul (KR)

(73) Assignee: LG ELECTRONICS INC., Seoul (KR)

(21) Appl. No.: 19/106,282

(22) PCT Filed: Oct. 13, 2022
(86) PCT No.: PCT/KR2022/015456

§ 371 Date: Feb. 25, 2025

(51) Int. Cl. B60R 1/04; B60R 1/12

(52) U.S. Cl. CPC B60R 1/04; B60R 1/12; B60R 2001/1223; B60R 2001/1276

(57) ABSTRACT

Abstract: The present embodiment may include; a ball shaft having a pair of balls connected by a shaft and having a wire receiving recess which accommodates a wire; a pair of ball housings having formed therein ball receiving portions which accommodate the balls; a pair of springs which are mounted in the ball housing and press the balls into the ball receiving portions; and a wire cover covering the wire receiving recess.

### TECHNICAL FIELD

The present invention relates to a mirror support for supporting a mirror and a mirror assembly having the same.

### BACKGROUND ART

An example of a mirror support may be a room mirror support for supporting a room mirror used in a vehicle, and the mirror support may be fixed to a glass or a roof panel of the vehicle and may adjust the angle of the room mirror.

US Patent Publication No. US8201800B2 (June 19, 2012, Patent) discloses a rearview mirror assembly, which comprises a receiver having a plurality of fingers defining a ball receiving area, at least one pivot ball arranged in the ball receiving area of the receiver, and a spring forming a circle and arranged around the fingers of the receiver.

### DISCLOSURE

### Technical Problem

The purpose of the present embodiment is to provide a mirror support having a simple structure and easy assembly and a mirror assembly having the same.

The purpose of the present invention is to provide a mirror support and a mirror assembly having the same, in which wires may be easily installed and the wires are hidden, thus providing a simple appearance.

### Technical Solution

A mirror assembly may comprise a mirror and a mirror support supporting the mirror.

The mirror support may comprise a ball shaft having a pair of balls connected by a shaft and a wire receiving groove formed to receive a wire; a pair of ball housings having a ball receiving portion formed to receive the ball; a pair of springs mounted on the ball housing and pressurizing the ball to the ball receiving portion; and a wire cover covering the wire receiving groove.

The mirror may comprise a mirror housing; a panel body disposed in front of the mirror housing; a display panel disposed inside the panel body; and a fixed bracket accommodated in the mirror housing and to which one of the pair of ball housings is fastened.

An insertion portion into which the ball shaft is inserted may be formed in the ball housing, and the insertion portion may communicate with the inside of the ball receiving portion.

The spring may be a plate spring comprising an elastic portion coming into contact with the ball, and a plurality of mounting portions bent at an end of the elastic portion and detachably mounted to the ball housing.

The ball housing may comprise a spring support portion into which one of the plurality of mounting portions is inserted and which supports one of the plurality of mounting portions; and a spring fastening portion to which the other of the plurality of mounting portions is fastened as a fastening member.

The ball receiving portion may comprise a curved surface making surface contact with the ball.

The ball receiving portion may comprise a through-hole through which the ball shaft passes.

The pair of ball housings may comprise a housing mirror coupled to a mirror; and a housing glass attached to a glass

The pair of springs may comprise a first spring mounted on the housing mirror and pressing one of the pair of balls into the ball receiving portion of the housing mirror; and a second spring mounted on the housing glass and urging the other of the pair of balls into the ball receiving groove of the housing glass.

One of the housing mirror and the ball shaft may be made of metal and the other may be made of plastic.

One of the housing glass and the ball shaft may be made of metal and the other may be made of plastic.

The mirror assembly further comprise a wire connector disposed on the housing glass.

The wire may comprise a first wire portion connected to the wire connector and received in the housing glass; and a second wire portion extending from the first wire portion and received by inserting to the wire receiving groove.

The mirror may comprise a main PCB; and a sub-PCB disposed at rear of the main PCB.

A first distance between the main PCB and the sub-PCB is shorter than a second distance between the main PCB and a front end of the mirror.

The first distance is shorter than a third distance between the sub-PCB and a rear end of the mirror.

### Advantageous Effect

According to the present embodiment, a wire receiving groove is formed in the ball shaft, and the wire may be easily installed by settling the wire in the wire receiving groove, and the wire cover covers the wire receiving groove, so that the wire can be fixed and protected with a simple structure.

In addition, an insertion portion is formed in the ball housing that communicates with the inside of the ball receiving portion and into which the ball shaft is inserted, so that the ball shaft assembly can be simplified.

In addition, since one of the housing mirror and the ball shaft is made of metal and the other is made of plastic, there is no need to install a separate finger socket for friction between the housing mirror and the ball shaft, and the number of parts may be minimized and material costs may be reduced.

In addition, since one of the housing glass and the ball shaft is made of metal and the other is made of plastic, there is no need to install a separate finger socket for friction between the housing glass and the ball shaft, and the number of parts may be minimized and material costs may be reduced.

In addition, since the spring may be mounted by inserting it into the housing mirror or the housing glass and then fastening the fastening member, the spring can be mounted with a simple operation and may be assembled reliably.

In addition, the first spring can maintain the frictional force between the housing mirror and the ball shaft, and may reliably support the mirror.

In addition, the second spring can maintain the frictional force between the housing glass and the ball shaft, and can reliably support the mirror and the ball shaft.

### DESCRIPTION OF DRAWINGS

FIG. 1 is a perspective view of a mirror assembly according to the present embodiment.

FIG. 2 is a cross-sectional view of a mirror assembly according to the present embodiment.

FIG. 3 is a view of an example of a mirror support according to the present embodiment.

FIG. 4 is an exploded perspective view of an example of a mirror support according to the present embodiment.

FIG. 5 is a cross-sectional view when a spring according to the present embodiment is coupled to a housing.

FIG. 6 is a front view illustrating an assembly process of a ball shaft and a ball housing according to the present embodiment.

FIG. 7 is a side view illustrating an assembly process of a ball shaft and a ball housing according to the present embodiment.

FIG. 8 is a cross-sectional view illustrating an installation process of a spring according to the present embodiment.

FIG. 9 is an exploded perspective view of a mirror according to the present embodiment.

FIG. 10 is a rear view of a mirror according to the present embodiment.

FIG. 11 is a plan view illustrating the inside of a mirror according to the present embodiment.

### BEST MODE

Hereinafter, specific embodiments of the present invention will be described in detail with reference to the drawings.

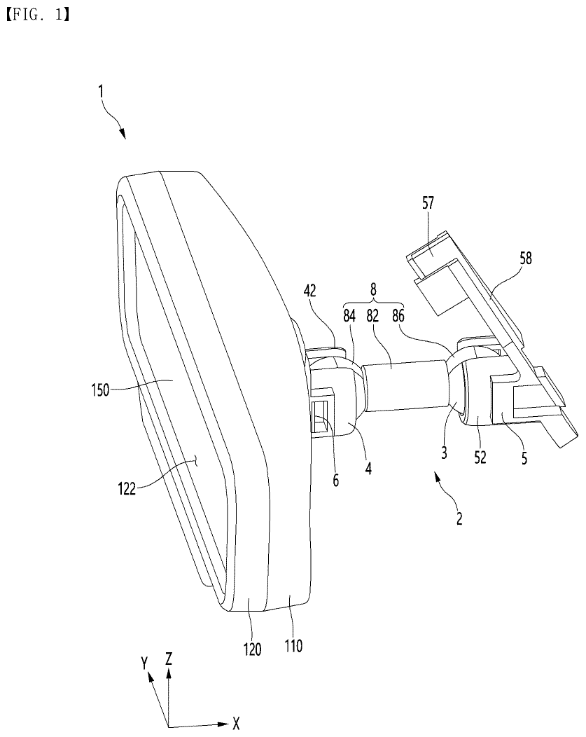

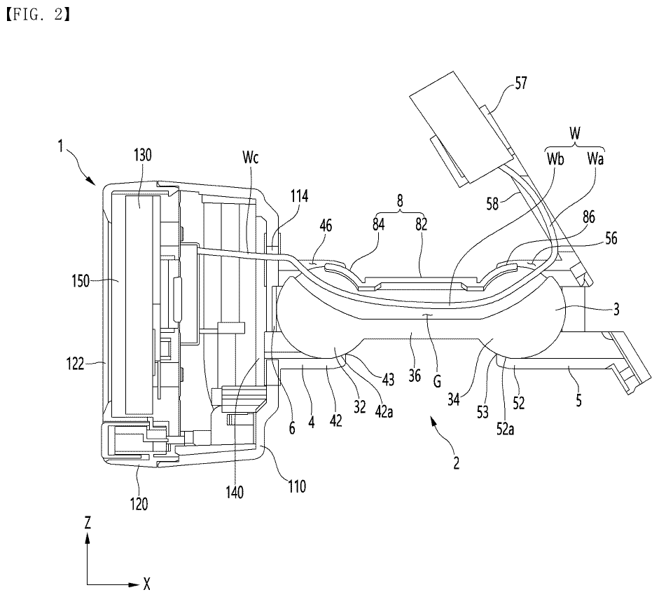

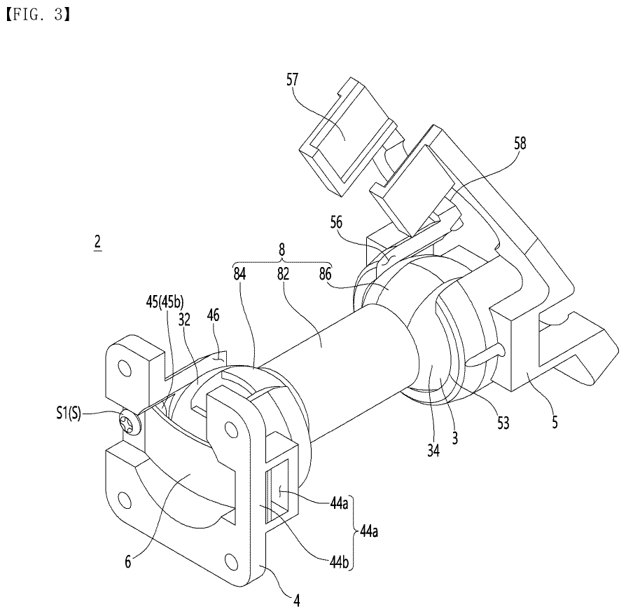

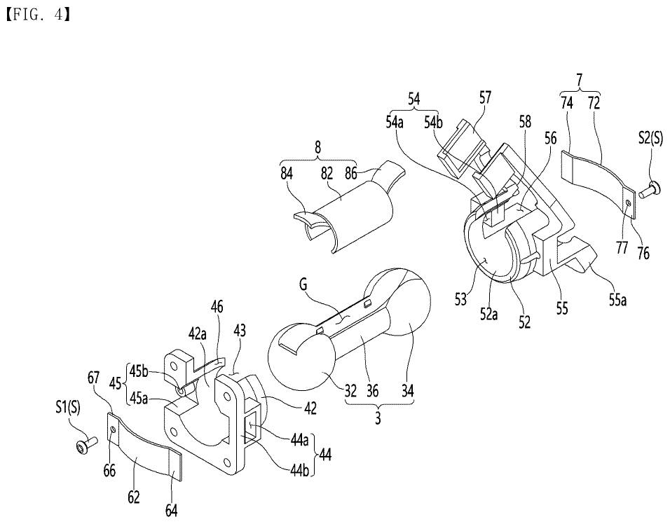

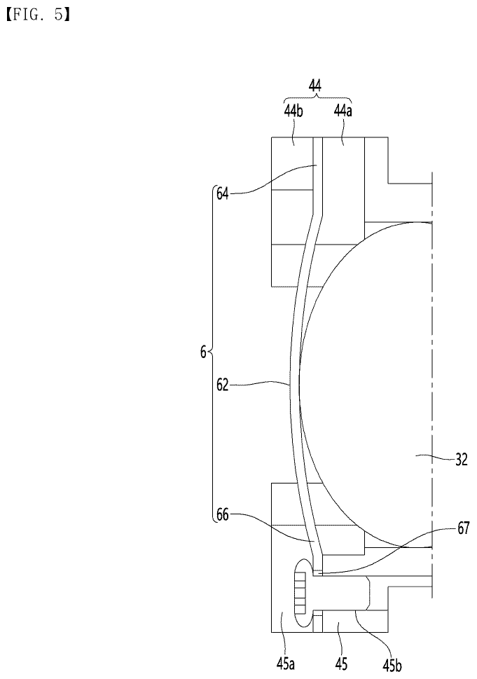

FIG. 1 is a perspective view of a mirror assembly according to the present embodiment, FIG. 2 is a cross-sectional view of a mirror assembly according to the present embodiment, FIG. 3 is a view of an example of a mirror support according to the present embodiment, FIG. 4 is an exploded perspective view of an example of a mirror support according to the present embodiment, and FIG. 5 is a cross-sectional view when a spring according to the present embodiment is coupled to a housing.

The mirror assembly may comprise a mirror 1 and a mirror support 2 supporting the mirror 1.

The mirror assembly may be installed in a vehicle to provide a rear view to the driver. An example of the mirror 1 may be a device for protecting the driver's eyes from the lights of a following vehicle when driving at night, and may be an ECM room mirror that detects light with a sensor installed in the mirror 1 and darkens the reflection of the mirror.

The mirror support 2 may be placed on the glass or roof panel of the vehicle and may support the mirror 1 so as to be angle-adjustable.

The mirror support 2 may comprise a ball shaft 3, a pair of ball housings(4 5, a pair of springs 6 and 7, and a wire cover 8.

The ball shaft 3 may have a pair of balls 32 and 34 connected to a shaft 36. The pair of balls 32 and 34 and the shaft 36 may be formed integrally.

A pair of balls 32 and 34 may be spaced apart with a shaft 36 therebetween. A pair of balls 32 and 34 may be formed at a longitudinal end of a shaft 36. A pair of balls 32 and 34 may be spaced apart in a front and rear direction X. Each of the pair of balls 32 and 34 may have an overall shape of a sphere or a shape close to a sphere. An outer circumferential surface of each of the pair of balls 32 and 34 may be curved.

A pair of balls 32 and 34 may comprise a first ball 32 and a second ball 34 spaced apart from each other.

The first ball 32 may be supported by one 4 of the pair of ball housings 4 and 5.

The second ball 34 may be supported by the other 5 of the pair of ball housings 4 and 5.

The shaft 36 may be a straight shape or a bent shape.

A pair of ball housings 4 and 5 may comprise a housing mirror 4 and a housing glass 5.

The housing mirror 4 may be coupled to the mirror 1.

The housing glass 5 may be attached to the glass.

The housing mirror 4 and the housing glass 5 may be respectively connected to the ball shaft 3.

The housing mirror 4 and the housing glass 5 may be kept apart from each other by the ball shaft 3. In a state where the housing glass 5 is attached to the glass, the housing mirror 4 may be hung on the housing glass 5 by the ball shaft 3 and may support the mirror 4.

The first ball 32 may be accommodated in the housing mirror 4, and the housing mirror 4 may rotate around the first ball 32, and the first ball 32 may rotate around the housing mirror 4.

The second ball 34 may be accommodated in the housing glass 5, and the second ball 34 may rotate around the housing glass 5.

The ball shaft 3 may have a wire receiving groove G formed in which a wire W is accommodated.

The wire receiving groove G may be formed in a sunken shape on the outer peripheral surface of the ball shaft 3.

One example of the wire receiving groove G may be formed on both the pair of balls 32 34 and the shaft 36, and another example of the wire receiving groove G may be formed only on the shaft 36.

Hereinafter, an example in which a wire receiving groove G is formed together with a pair of balls 32 34 and a shaft 36 is described.

The wire receiving groove G of the shaft 36 may be formed by being sunken into the outer circumference of the shaft 36, and the wire receiving groove G of the shaft 36 may be formed long in the longitudinal direction of the shaft 36.

The wire receiving groove G formed in the pair of balls 32 34 may be formed by being recessed into the outer circumference of the balls 32 34. The wire receiving groove G formed in the pair of balls 32 34 may communicate with the wire receiving groove G of the shaft 36, and may be formed symmetrically with respect to the wire receiving groove G of the shaft 36.

The pair of ball housings 4 and 5 may comprise a ball receiving portion in which balls are received. The ball receiving portion may comprise a curved surface that makes surface contact with the balls. A pair of ball housings 45 may comprise a spring support portion in which a spring 67 is supported. The ball housing 45 may have an insert portion formed through which a ball shaft 3 is inserted. The insert portion may pass through a ball receiving portion.

That is, the ball shaft 3 may comprise a ball 3234 received inside the ball housing 45 and a shaft 36 extended from the ball 3234 to the outside of the ball housing 45.

A housing mirror 4 of one of the pair of ball housings 45 may comprise a first ball receiving portion 42 in which a first ball 32 is received. A ball receiving space in which the first ball 32 is received may be formed inside the first ball receiving portion 42. The housing mirror 4 may have an open back surface. A through portion through which the ball shaft 3 is passed through may be formed in the first ball receiving portion 42. The penetration portion may be formed in the front portion of the housing mirror 4. The penetration portion may be open in the front and rear direction X.

The first ball receiving portion 42 may comprise a first curved surface 42a that is in surface contact with the first ball 32. The first curved surface 42a may be formed on the inside of the first ball receiving portion 42. The first curved surface 42a may be in surface contact with a portion of the outer surface of the first ball 32.

The first ball receiving portion 42 may have a penetration portion 43 formed through which the ball shaft 3 is passed. The penetration portion 43 may be formed in the front portion of the housing mirror 4. The penetration portion 53 may be an opening that is open in the front and rear direction X.

The housing mirror 4 may comprise a first spring support 44 on which the first spring 6 is supported and a first spring fastening portion 45 on which the first spring 6 is fastened.

The first spring support portion 44 may be formed on either the left or right side of the housing mirror 4, and the first spring fastening portion 45 may be formed on the other of the left or right side of the housing mirror 4.

The first spring support portion 44 may comprise an opening 44a into which the mounting portion 64 of the first spring 6 is inserted, and may comprise a side wall 44b on which the mounting portion 64 of the first spring 6 is caught. The opening 44a may be opened in the left and right directions Y.

The first spring fastening portion 45 may comprise an insertion groove portion 45a into which the mounting portion 66 of the first spring 6 is inserted in the front and rear direction X, and a fastening hole 45b into which a first fastening member S1 such as a screw is fastened may be formed.

The housing mirror 4 may be formed with a first insertion portion 46 into which the ball shaft 3 is inserted. The first insertion portion 46 may communicate with the interior of the first ball receiving portion 42.

The first insertion portion 46 may comprise an opening that is open in the upper portion of the first ball receiving portion 42 in the up/down direction Z. The first insertion portion 46 may be formed long in the front and rear direction X of the first ball receiving portion 42. The left/right width of the opening may be smaller than the diameter of the first ball 32 and larger than the diameter of the shaft 36.

When mounting the ball shaft 3 to the housing mirror 4, the shaft 36 may pass through the first insertion portion 46, and the first ball 42 may be inserted into and accommodated inside the first ball receiving portion 42.

The other of the pair of ball housings 45, the housing glass 5, may comprise a second ball receiving portion 52 in which the second ball 34 is accommodated. A ball receiving space in which the second ball 34 is accommodated may be formed inside the second ball receiving portion 52. The housing glass 5 may be open at the front. A through-hole through which the ball shaft 3 passes may be formed at the second ball receiving portion 52. The through-hole may be formed at the rear portion of the housing glass 4. The through-hole may be open in the front and rear direction X.

The second ball receiving portion 52 may comprise a second curved surface 52a that comes into surface contact with the second ball 34. The second curved surface 52a may be formed on the inside of the second ball receiving portion 52. The second curved surface 52a may come into surface contact with a portion of the outer surface of the second ball 34.

A through-hole 53 through which the ball shaft 3 passes may be formed in the second ball receiving portion 52. The through-hole 53 may be formed at the rear end of the second ball receiving portion 52. The through-hole 53 may be an opening that is open in the front and rear direction X.

The housing glass 5 may comprise a second spring support portion 54 on which the second spring 7 is supported and a second spring fastening portion 55 on which the second spring 7 is fastened.

The second spring support 54 may be formed on either the left or right side of the housing glass 5, and the second spring fastening portion 55 may be formed on the other of the left or right side of the housing glass 4.

The second spring support 54 may be formed with the same structure as the first spring support 44. The second spring support 54 may comprise an opening 54a into which the mounting portion 74 of the second spring 7 is inserted, and a side wall 54b on which the mounting portion 74 of the second spring 7 is caught. The opening 54a may be opened in the left and right direction Y.

The second spring fastening portion 55 may be formed with the same structure as the first spring fastening portion 45. The second spring fastening portion 55 may comprise an insertion groove portion 55a into which the mounting portion 76 of the second spring 6 is inserted in the front and rear direction X, and a fastening hole not shown into which a second fastening member S2 such as a screw is fastened may be formed.

The housing glass 5 may be formed with a second insertion portion 56 into which the ball shaft 3 is inserted. The second insertion portion 56 may communicate with the interior of the second ball receiving portion 52.

The second insertion portion 56 may comprise an opening that is open in the upper portion of the second ball receiving portion 52 in the up/down direction Z. The second insertion portion 56 may be formed long in the front and rear direction X of the second ball receiving portion 52. The left/right width of the opening may be smaller than the diameter of the second ball 34 and larger than the diameter of the shaft 36.

When mounting the ball shaft 3 to the housing glass 5, the shaft 36 may pass through the second insertion portion 56, and the second ball 34 may be inserted into and accommodated in the second ball receiving portion 52.

A pair of springs 67 may comprise a first spring 6 and a second spring 7.

The first spring 6 may be coupled to the housing mirror 4 and may press the first ball 32 to the housing mirror 4.

The second spring 7 may be coupled to the housing glass 5 and may press the second ball 34 to the housing glass 5.

The pair of springs 6 and 7 may be supported by a spring support. The pair of springs 6 and 7 may be fastened to the spring fastening portion by a fastening member S. The pair of springs 6 and 7 may press the ball 32 and 34 to the ball receiving portion 42 and 45.

The spring 6 and 7 may be a plate spring, and the plate spring may comprise an elastic portion and a mounting portion. The elastic portion may be in 13 contact with the ball. The mounting portion may be bent at an end of the elastic portion. The mounting portion may be formed in plurality, and one of the plurality of mounting portions may be inserted into the spring support portion and supported by the spring support portion. Another of the plurality of mounting portions may be fastened to the spring fastening portion.

The first spring 6 is supported by the spring support portion 44 of the housing mirror 4, may be fastened to the spring fastening portion 45 of the housing mirror 4, and may press one 32 of the pair of balls 32 and 34 to the ball receiving portion 42 of the housing mirror 4.

The first spring 6 may comprise an elastic portion 62 that comes into contact with the first ball 32, and a pair of mounting portions 64 and 66 formed on the elastic portion 62.

The elastic member 62 may press the first ball 32 forward so that a portion of the outer surface of the first ball 32 comes into surface contact with the first curved surface 42a. The elastic member 62 may press the first ball 32 to the first curved surface 42a, and frictional force may occur between the first ball 32 and the first curved surface 42a.

A pair of mounting portions 64 and 66 may be formed by bending at an end of the elastic member 62.

A pair of mounting portions 64 and 66 may be detachably mounted to the ball housing 45.

A pair of mounting portions 64 and 66 may comprise a right mounting portion 64 and a left mounting portion 66. A fastening hole 67 that may be fastened to a fastening member S such as a screw may be formed in one of the left mounting portion 64 and the right mounting portion 66 to the spring fastening portion 45.

The ball receiving portion 42 of the housing mirror 4 may be a first ball receiving portion 42 in which the first ball 32 is received, the spring support portion 44 of the housing mirror 4 may be a first spring support portion 44 that supports the first spring 6, and the spring fastening portion 45 of the housing mirror 4 may be a first spring fastening portion 45 in which the first spring 6 is fastened.

The second spring 7 is supported on the spring support 54 of the housing glass 5, and may be fastened to the spring fastening portion 55 of the housing glass 5, and may pressurize the other 34 of the pair of balls 32 and 34 into the ball receiving portion 52 of the housing glass 5.

The second spring 7 may comprise an elastic portion 72 that comes into contact with the second ball 34, and a pair of mounting portions 74 and 76 formed on the elastic portion 72.

The elastic portion 72 may pressurize the second ball 34 in the rearward direction so that a portion of the outer surface of the second ball 34 comes into surface contact with the second curved surface 52a. The elastic member 72 may press the second ball 34 to the second curved surface 52a, and frictional force may occur between the second ball 34 and the second curved surface 52a.

A pair of mounting portions 74 and 76 may be formed by bending at the end of the elastic member 72.

A pair of mounting portions 74 and 76 may comprise a left mounting portion 74 and a right mounting portion 76. A fastening hole 77 that may be fastened to a fastening member S such as a screw in the spring fastening part 55 may be formed in one of the left mounting portion 74 and the right mounting portion 76.

The ball receiving portion 52 of the housing glass 5 may be a second ball receiving portion 52 in which the second ball 34 is received, the spring support portion 54 of the housing glass 5 may be a second spring support portion 54 that supports the second spring 7, and the spring fastening portion 55 of the housing glass 5 may be a second spring fastening portion 55 in which the second spring 7 is fastened.

Either the housing mirror 4 or the ball shaft 3 may be metal, and the other may be plastic. Either the housing glass 5 or the ball shaft 3 may be metal, and the other may be plastic.

For example, when the housing mirror 4 and the housing glass 5 are metal, the ball shaft 3 may be plastic. As the other example, when the housing mirror 4 and the housing glass 5 are plastic, the ball shaft 3 may be metal.

In this case, the ball shaft 3 may be rubbed against each of the housing mirror 4 and the housing glass 5, and the first spring 6 and the second spring 7, which are plate springs, may maintain this frictional force.

The housing glass 5 may further comprise a connector fixing portion 57 to which a wire connector C is fixed, and a wire penetration portion 58 through which a wire W passes.

The connector fixing portion 57 may be formed other than the second ball receiving portion 52. The connector fixing portion 57 may be formed on the upper portion of the housing glass 5. The wire connector C to which the wire W is connected may be inserted and mounted in the connector fixing portion 57.

The wire penetration portion 58 may be formed to be long in the longitudinal direction of the housing glass 5.

As shown in FIG. 2, the wire W may have one end connected to the wire connector C, may pass through the wire penetration portion 58 and the wire receiving groove G, and may extend inside the mirror 1.

A cover penetration hole 114 through which the wire W passes may be formed in the mirror housing 110 of the mirror 1. The cover penetration hole 114 may be formed to be open in the front and rear direction X of the mirror housing 110.

The wire W may comprise a first wire portion Wa connected to the wire connector C and received in the housing glass 5, a second wire portion Wb extended from the first wire portion Wa and received by inserting the wire receiving groove G, and a third wire portion Wc extended from the second wire portion Wb and passing through the cover penetration hole 114.

The wire cover 8 may be configured to cover the wire receiving groove G and the wire W. The wire cover 8 may be arranged on the ball shaft 3 to cover the wire receiving groove G and may fix and protect the wire W received in the wire receiving groove G.

The wire cover 8 may comprise a shaft shield 82 that covers and shields the wire receiving groove G of the shaft 36. The shaft shield 82 may have a shape that covers the periphery of the wire receiving groove G of the shaft 36. The cross section of the shaft shield 82 may have a friendly shape. The shaft shield 82 may have a shape that surrounds the shaft 36 and may be combined with the shaft 36.

The wire cover 8 may comprise a first ball shield 84 that covers and shields the wire receiving groove G of the first ball 32. The first ball shield 84 may protrude backward from the shaft shield 82. The first ball shield 84 may have a curved outer surface, like the outer surface of the first ball 32. The first ball shield 84 may be inserted into the wire receiving groove G of the first ball 32 and fitted to the first ball 34.

The wire cover 8 may comprise a second ball shield 86 that covers and shields the wire receiving groove G of the first ball 32. The second ball shield 86 may protrude forward from the shaft shield 82. The second ball shield 86 may have a curved outer surface, like the outer surface of the second ball 34. The second ball shield 86 may be inserted into the wire receiving groove G of the second ball 34 and fitted to the second ball 34.

The mirror 1 may comprise a mirror housing 110 and a panel body 120 disposed in front of the mirror housing 110. The mirror housing 110 and the panel body 120 may form a mirror casing forming the exterior of the mirror 1.

The mirror housing 110 may form the front exterior of the mirror 1 and the exterior of a portion of the periphery.

The panel body 120 may form the exterior of the remaining periphery of the mirror 1. The panel body 120 may have an opening 122 formed on the back surface.

The mirror 1 may further comprise a display panel 130. The display panel 130 may be disposed inside the mirror casing. The display panel 130 may be disposed inside the mirror housing 110 or inside the panel body 120. Hereinafter, the display panel 130 may be disposed inside the panel body 120, and the panel body 120 may surround the periphery of the display panel 130.

The mirror 1 may comprise a fixed bracket 140 to which the mirror support 2 is fixed by a fastening member such as a screw.

The fixed bracket 140 may be accommodated in the mirror housing 110. The fixed bracket 40 may be fixed to one 4 of a pair of ball housings. A housing mirror 4 may be fixed to the fixed bracket 40. The housing mirror 4 may be fixed to the fixed bracket 140 by a fastening member such as a screw. The fastening member such as a screw may be fixed to the fixed bracket 140 by penetrating a fastening hole formed in the housing mirror 40 and a fastening hole formed in the mirror housing 110.

The mirror 1 may comprise an ECM (electronic chromic mirror) 150 disposed at the rear of the display panel 130.

The ECM 150 may be a photosensitive mirror, and may comprise two low-reflectivity mirrors and a high-reflectivity mirror that are overlapped. The ECM 150 may also comprise a sensor that recognizes light. The ECM 150 may have a plate shape or a sheet shape as a whole.

The ECM 150 may normally shine with a high-reflectivity mirror, and when strong light hits the sensor, it may suppress the light from being reflected by utilizing a low-reflectivity mirror.

The ECM 150 may be accommodated inside the panel body 120 and may be visible through an opening 122 of the panel body 120.

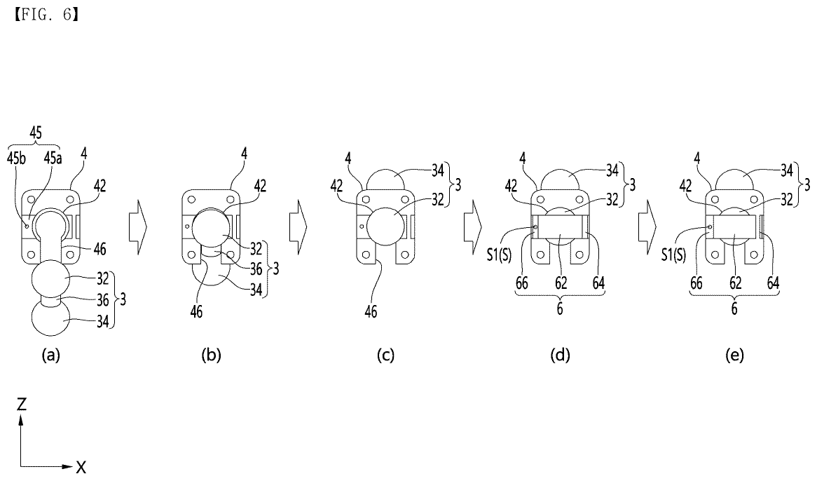

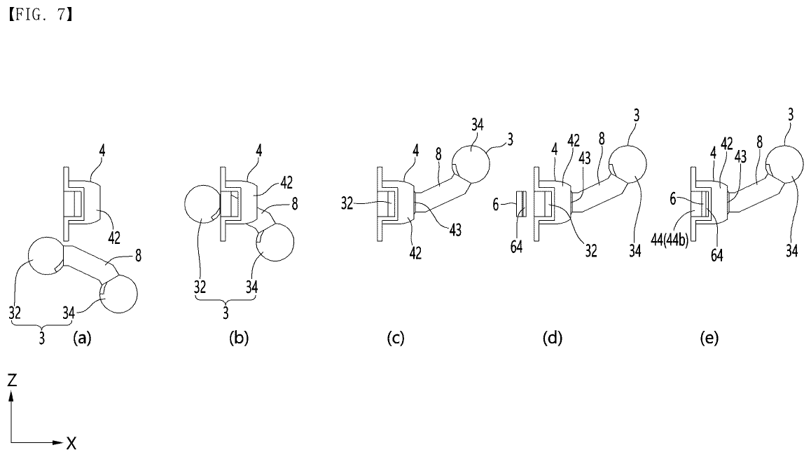

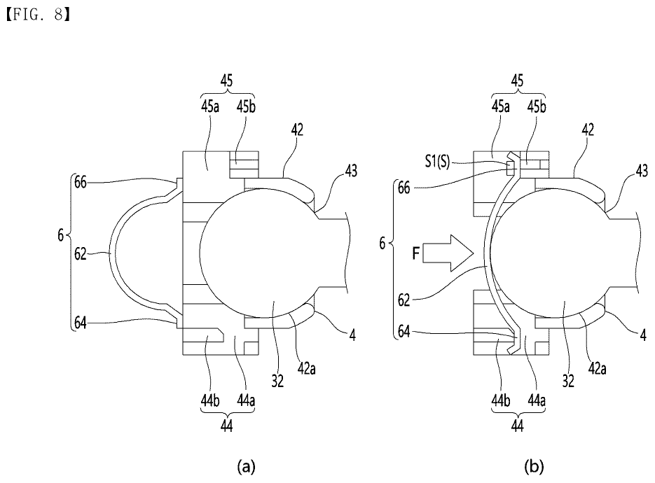

FIG. 6 is a front view illustrating the assembly process of the ball shaft and the ball housing according to the present embodiment, FIG. 7 is a side view illustrating the assembly process of the ball shaft and the ball housing according to the present embodiment, and FIG. 8 is a cross-sectional view illustrating the spring mounting process according to the present embodiment.

The ball shaft 3 may be inserted into the housing mirror 4 through the insertion portion 46, and the insertion direction of the first spring 6 is configured from the outside to the inside of the housing mirror 4, so that the assembly of the mirror support may be simplified.

The ball shaft 3 may be positioned at the lower side of the housing mirror 4 as illustrated a in FIG. 6 and a FIG. 7 before assembly, and may be raised as illustrated b in FIG. 6 and b FIG. 7 b.

When the ball shaft 3 rises, the shaft 36 of the ball shaft 3 may pass through the insertion portion 46 of the housing mirror 4, and the first ball 32 may be positioned at the rear of the first ball receiving portion 42, as shown in b of FIG. 7

In a state where the first ball 32 is positioned at the rear of the first ball receiving portion 42, as shown in b of FIG. 7, the worker may pull the ball shaft 3 forward, and the first ball 32 may be inserted into the interior of the first ball receiving portion 42, as shown in c of FIG. 6 and c of FIG. 7, and the ball shaft 3 may pass through the penetration portion 43 of the housing mirror 4.

Thereafter, the worker may position the first spring 6 at the rear of the first ball 32, as shown in d of FIG. 6 and d of FIG. 7, and may deform the first spring 6 into a shape in which the elastic part 62 is bent, as shown in a of FIG. 8. The first spring 6 may be elastically deformed so that the gap between the pair of mounting portions 64 and 66 is narrowed, as shown in a of FIG. 8.

The first spring 6 may be moved in the forward direction F (shown in FIG. 8) as shown in b of FIG. 8, so that one of the pair of mounting portions 64 and 66 may be inserted into the first spring support part 44, and the other of the pair of mounting portions 64 and 66 may be inserted into the first spring fastening part 45 with a fastening member S1 such as a screw.

One of the pair of mounting portions 64 and 66 may be inserted into the opening 44a and fixed in the rearward direction to the side wall 44b, and the other of the pair of mounting portions 64 and 66 may be fixed to the fixing hole 45b formed in the first spring fixing part 45 by a fixing member S1 such as a screw.

The elastic part 62 may elastically press the first ball 42 to the first curved surface 42a, and the ball shaft 3 may be assembled to the housing mirror 4, as shown in e of FIG. 6 and e of FIG. 7.

The ball shaft 3 may be assembled to the housing glass 5, and the ball shaft 3 may firmly support the housing mirror 4 and the mirror 1 while being assembled to the housing mirror 4 and the housing glass 5.

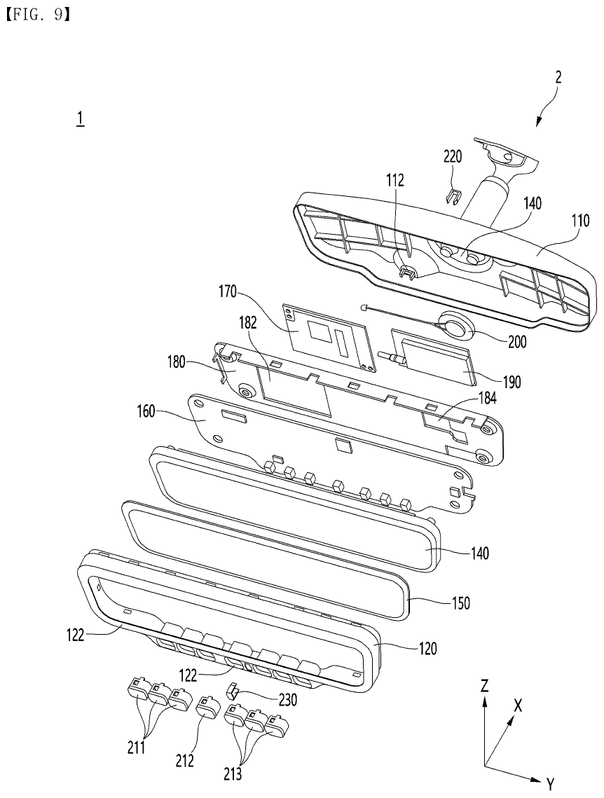

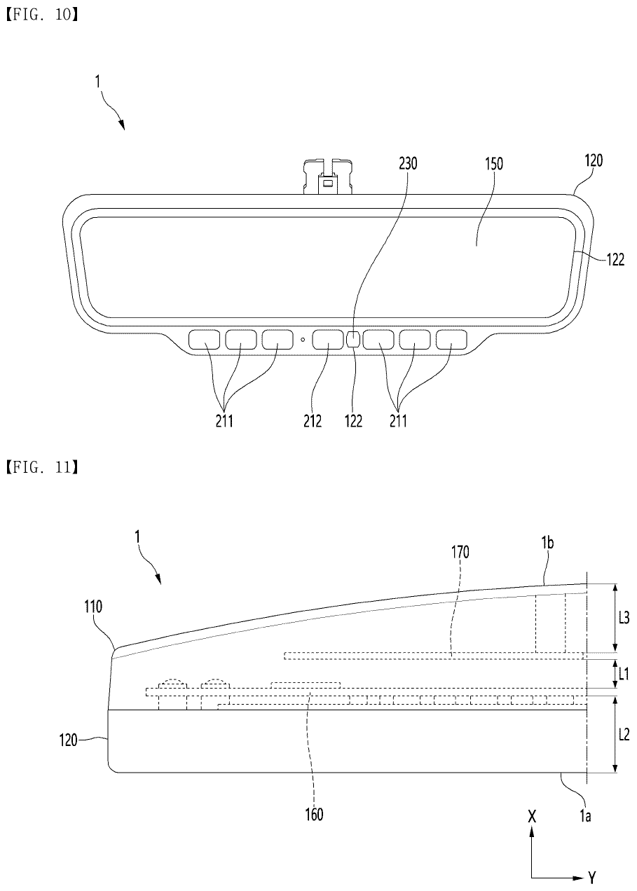

FIG. 9 is an exploded perspective view of a mirror according to the present embodiment, FIG. 10 is a rear view of a mirror according to the present embodiment, and FIG. 11 is a plan view showing the inside of a mirror according to the present embodiment.

The mirror 1 may further comprise a main PCB 160 and a sub PCB 170 positioned rearward of the main PCB 160.

The main PCB 160 and the sub PCB 170 may be accommodated inside the mirror housing 110 or inside the panel body 120.

The display panel 140 may be disposed rearward of the main PCB 160, and the ECM 150 may be disposed rearward of the display panel 140.

The main PCB 160 and the sub PCB 170 may be spaced apart in the front and rear direction X.

The main PCB 160 may be spaced apart from the front end of the mirror 1 in the front and rear direction X.

The sub PCB 170 may be spaced apart from the rear end of the mirror 1 in the front and rear direction X.

It is preferable that the thickness of the mirror 1 in the front and rear direction X is optimized.

As shown in FIG. 11, the main PCB 160 and the sub PCB 170 may be spaced apart by a first distance L1, the main PCB 160 may be spaced apart by a second distance L2 from the front end 1a of the mirror 1, and the sub PCB 170 may be spaced apart by a third distance L3 from the rear end 1b of the mirror 1.

The first distance L1 between the main PCB 160 and the sub PCB 170 may be shorter than the second distance L2 between the main PCB 160 and the front end 1a of the mirror 1, as shown in FIG. 10.

The first distance L1 between the main PCB 160 and the sub PCB 170 may be shorter than the third distance L3 between the sub PCB 170 and the rear end 1b of the mirror 1, as shown in FIG. 11.

The mirror 1 may comprise a bracket 180, see FIG. 9 on which the main PCB 160 is mounted. The bracket 180 may be disposed inside the mirror housing 110 or inside the panel body 120. The bracket 180 may comprise a heat sink.

An opening 182 for connecting the sub-PCB 170 and the main PC 160 may be formed in the bracket 180.

The sub-PCB 170 may be connected to the main PC 160 by a connector such as a wire, and the connector or the sub-PCB 170 may pass through the opening 182.

The mirror 1 may further comprise a HIPASS PC 190 and a speaker 200.

The HIPASS PC 190 and the speaker 200 may be accommodated between the bracket 180 and the mirror housing 110. The HIPASS PC 190 may be connected to the main PC 160 by a connector such as a wire, and the bracket 180 may be formed with a connector opening 184 through which the connector passes.

When the mirror 1 comprises an ECM 150, a HIPASS PCB 190, and a speaker 200, the mirror 1 may be an ECM high-pass room mirror.

The mirror 1 may comprise at least one button 211, 212 and 213 disposed on the panel body 120. At least one button 211, 212 and 213 may be disposed in plurality on the lower part of the panel body 120, and the pluratiy of buttons 211, 212 and 213 may be disposed in a row in the left-right direction Y.

The multiple buttons 211, 212 and 213 may comprise a home link button 211, a screen change button 212, and a menu movement button 213.

The mirror 1 may comprise at least one light sensor. At least one light sensor may comprise a rear light sensor for sensing rear light, and a front light sensor for sensing front light.

A front light sensor window 220 for the front light sensor may be disposed in the mirror housing 110. A front mounting portion 112 on which the front light sensor window 220 is mounted may be formed in the mirror housing 110.

A rear light sensor reflector 230 for the rear light sensor may be disposed in the panel body 120. A rear mounting portion 122 on which the rear light sensor reflector 230 is disposed may be formed in the panel body 120.

The above description is merely an illustrative explanation of the technical idea of the present disclosure, and various modifications and variations will be possible to those skilled in the art without departing from the essential characteristics of the present disclosure.

Accordingly, the embodiments disclosed in the present disclosure are not intended to limit the technical idea of the present disclosure, but rather to explain it, and the scope of the technical idea of the present disclosure is not limited by these embodiments.

The scope of protection of the present disclosure should be interpreted in accordance with the claims below, and all technical ideas within the equivalent scope should be construed as being comprised in the scope of rights of the present disclosure.

1-15. (canceled)

16. A mirror support comprising:
a ball shaft having a pair of balls connected by a shaft and a wire receiving groove formed to receive a wire;
a pair of ball housings having a ball receiving portion formed to receive the ball;
a pair of springs mounted on the ball housing and pressurizing the ball to the ball receiving portion; and
a wire cover covering the wire receiving groove,
wherein the spring is a plate spring and comprises:
an elastic portion coming into contact with the ball; and
a plurality of mounting portions bent at an end of the elastic portion and detachably mounted to the ball housing,
wherein the ball housing comprises:
a spring support portion into which one of the plurality of mounting portions is inserted and which supports one of the plurality of mounting portions; and
a spring fastening portion to which the other of the plurality of mounting portions is fastened as a fastening member, and
wherein a fastening hole into which the fastening member is fastened is formed.

17. The mirror support of claim 16, wherein an insertion portion into which the ball shaft is inserted is formed in the ball housing, and the insertion portion communicates with the inside of the ball receiving portion.

18. The mirror support of claim 16, wherein the ball receiving portion comprises a curved surface making surface contact with the ball.

19. The mirror support of claim 16, wherein the ball receiving portion comprises a through-hole through which the ball shaft passes.

20. The mirror support of claim 16, wherein the pair of ball housings comprises:
a housing mirror coupled to a mirror, and
a housing glass attached to a glass, and
wherein the pair of springs comprises:
a first spring mounted on the housing mirror and pressing one of the pair of balls into the ball receiving portion of the housing mirror; and
a second spring mounted on the housing glass and urging the other of the pair of balls into the ball receiving groove of the housing glass.

21. The mirror support of claim 20, wherein one of the housing mirror and the ball shaft is made of metal and the other is made of plastic.

22. The mirror support of claim 20, wherein one of the housing glass and the ball shaft is made of metal and the other is made of plastic.

23. The mirror support of claim 20, further comprising a wire connector disposed on the housing glass,
wherein the wire comprises:
a first wire portion connected to the wire connector and received in the housing glass; and
a second wire portion extending from the first wire portion and received by inserting to the wire receiving groove.

24. A mirror assembly having a mirror support, the mirror assembly comprising:
a mirror; and
a mirror support supporting the mirror,
wherein the mirror support comprises:
a ball shaft having a pair of balls connected by a shaft and a wire receiving groove formed to receive a wire;
a pair of ball housings having a ball receiving portion formed to receive the ball;
a pair of springs mounted on the ball housing and pressing the ball to the ball receiving portion; and
a wire cover covering the wire receiving groove;
wherein the mirror comprises:
a mirror housing;
a panel body disposed in front of the mirror housing;
a display panel disposed inside the panel body; and
a fixed bracket accommodated in the mirror housing and to which one of the pair of ball housings is fastened,
wherein the spring is a plate spring and comprises:
an elastic portion coming into contact with the ball; and
a plurality of mounting portions bent at an end of the elastic portion and detachably mounted to the ball housing,
wherein the ball housing comprises:
a spring support portion into which one of the plurality of mounting portions is inserted and which supports one of the plurality of mounting portions; and
a spring fastening portion to which the other of the plurality of mounting portions is fastened as a fastening member, and
wherein a fastening hole into which the fastening member is fastened is formed.

25. The mirror assembly of claim 24, wherein the spring comprises:
an elastic portion coming into contact with the ball; and
a plurality of mounting portions bent at an end of the elastic portion and detachably mounted on the ball housing, and
wherein the ball housing comprises:
a spring support portion supporting one of the plurality of mounting portions; and
a spring fastening portion to which the other of the plurality of mounting portions is fastened as a fastening member.

26. The mirror assembly of claim 24, wherein the pair of ball housings comprises:
a housing mirror coupled to a mirror; and
a housing glass attached to a glass, and
wherein the pair of springs comprises:
a first spring mounted on the housing mirror and pressing one of the pair of balls into the ball receiving portion of the housing mirror; and
a second spring mounted on the housing glass and urging the other of the pair of balls into the ball receiving portion of the housing glass.

27. The mirror assembly of claim 24, wherein the mirror comprises:
a main printed circuit board (PCB); and
a sub-PCB disposed at rear of the main PCB, and
wherein a first distance between the main PCB and the sub-PCB is shorter than a second distance between the main PCB and a front end of the mirror.

28. The mirror assembly of claim 27, wherein the first distance is shorter than a third distance between the sub-PCB and a rear end of the mirror.
